(19) United States
(12) Patent Application Publication
(10) Pub. No.: US 2024/0372063 A1
(43) Pub. Date: Nov. 7, 2024

(54) Primary Battery

(71) Applicant: Nippon Telegraph and Telephone Corporation, Tokyo (JP)

(72) Inventors: Masaya Nohara, Musashino-shi, Tokyo (JP); Sho Okubo, Musashino-shi, Tokyo (JP); Mikayo Iwata, Musashino-shi, Tokyo (JP); Shuhei Sakamoto, Musashino-shi, Tokyo (JP); Hiroaki Taguchi, Musashino-shi, Tokyo (JP); Takeshi Komatsu, Musashino-shi, Tokyo (JP)

(21) Appl. No.: 18/692,562

(22) PCT Filed: Oct. 28, 2021
(86) PCT No.: PCT/JP2021/039839

§ 371 Date: Mar. 15, 2024

(51) Int. Cl. H01M 4/06; H01M 4/02; H01M 4/46; H01M 4/60; H01M 4/66

(52) U.S. Cl. CPC H01M 4/06; H01M 4/46; H01M 4/60; H01M 4/661; H01M 2004/029

(57) ABSTRACT

A primary battery includes a positive electrode containing isatin, a negative electrode containing magnesium or aluminum, and an electrolyte disposed between the positive electrode and the negative electrode.

### TECHNICAL FIELD

The present invention relates to a primary battery.

### BACKGROUND ART

As a disposable primary battery and as a rechargeable secondary battery, alkaline batteries, manganese batteries, high-performance coin-type lithium primary batteries, nickel-cadmium batteries, nickel-metal hydride batteries, lithium ion batteries, and the like have been widely used conventionally in small devices, sensors, mobile devices, and the like. Furthermore, as the Internet of Things (IOT) has been developed recently, scattered type sensors that are to be set and used at various places in nature, such as in the soil and in forests, has been developed accordingly.

Batteries generally used currently often include a rare metal such as lithium, nickel, manganese, or cobalt, and have a resource depletion problem.

An air battery having a low environmental load has also been studied (Patent Literature 1).

### CITATION LIST

### Patent Literature

Patent Literature 1: Japanese Patent No. 6711915

### SUMMARY OF INVENTION

### Technical Problem

The basis of the battery of Patent Literature 1 is the basis of an air battery, and the battery uses oxygen in the air as a positive electrode active material, and therefore an air intake port is essential for the battery. Therefore, the air battery has a disadvantage that an electrolytic solution volatilizes from the air intake port and is not suitable for long-term storage. Therefore, a new battery having a low environmental load and capable of battery reaction in a sealed system is required.

The present invention has been made in view of the above circumstances, and an object of the present invention is to provide a primary battery having a low environmental load and capable of being stored for a long period of time.

### Solution to Problem

A primary battery according to an aspect of the present invention includes a positive electrode containing isatin, a negative electrode containing magnesium or aluminum, and an electrolyte disposed between the positive electrode and the negative electrode.

### Advantageous Effects of Invention

The present invention can provide a primary battery having a low environmental load and capable of being stored for a long period of time.

### BRIEF DESCRIPTION OF DRAWINGS

FIG. 1 is a basic schematic diagram of a primary battery of the present embodiment.

FIG. 2 is a schematic cross-sectional view illustrating a structure of a coin-type primary battery.

FIG. 3A is a configuration diagram illustrating a configuration example of a bipolar stack primary battery.

FIG. 3B is a plan view illustrating a configuration example of a bipolar stack primary battery.

FIG. 4 is a graph illustrating a discharge curve of a primary battery of Example 1.

### DESCRIPTION OF EMBODIMENTS

Hereinafter, an embodiment of the present invention will be described with reference to the drawings.

### Configuration of Primary Battery

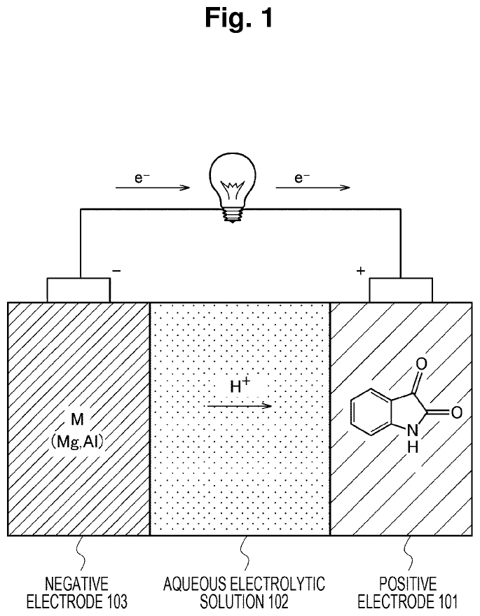

FIG. 1 is a configuration diagram illustrating a configuration of a primary battery according to the embodiment of the present invention. This primary battery includes a positive electrode 101 containing isatin, a negative electrode 103 containing magnesium or aluminum, and an electrolyte 102 disposed between the positive electrode 101 and the negative electrode 103. As the electrolyte 102, an aqueous electrolytic solution 102 is preferably used. In the present embodiment described below, a case where the aqueous electrolytic solution 102 is used as the electrolyte 102 will be described as an example, but the present invention is not limited thereto.

Specifically, the positive electrode 101 is formed using isatin as an active material. The negative electrode 103 is formed using magnesium or aluminum as an active material. The aqueous electrolytic solution (electrolyte) 102 is disposed so as to be in contact with the positive electrode 101 and the negative electrode 103. As described above, the primary battery of the present embodiment is characterized in that the positive electrode 101 contains an active material of isatin and the negative electrode 103 contains an active material of magnesium or aluminum.

Isatin is also referred to as 1H-indole-2, 3-dione. Isatin is one of heterocyclic compounds containing a nitrogen atom in the ring.

A discharge reaction in the positive electrode 101 can be expressed as follows.

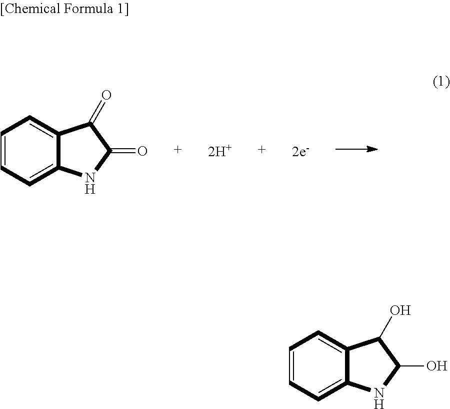

When a hydrogen ion (H⁺) to be described later reacts with the positive electrode 101, the ketone group of isatin changes to a hydroxy group.

A discharge reaction in the negative electrode 103 can be expressed as follows. Hereinafter, a reaction will be described in which, for example, magnesium (Mg) is used in the negative electrode 103.

$$Mg + 2 {H}_{2} O \to {Mg ( OH )}_{2} + 2 {H}^{+} + 2 {e}^{-} \qquad ( 2 )$$

The hydrogen ions (H⁺) in the above formula are dissolved in the aqueous electrolytic solution 102 from the negative electrode 103 by electrochemical reduction, and move to a surface of the positive electrode 101 in the aqueous electrolytic solution 102.

Note that the discharge reaction when aluminum (Al) is used for the negative electrode 103 is also reacted with hydrogen ions (H⁺) as follows, similarly to magnesium (Mg).

Al+3H₂O→Al(OH)₃+3H⁺+3e⁻

Due to these reactions of formulas (1) and (2), discharge is possible, and a total reaction can be expressed as follows.

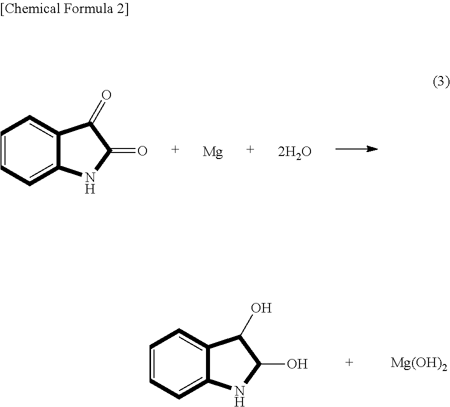

The theoretical electromotive forces are about 2 V (when isatin is used for the positive electrode active material and Mg is used for the negative electrode active material) and about 1 V (when isatin is used for the positive electrode active material and Al is used for the negative electrode active material).

For the primary battery of the present embodiment, isatin is used as a positive electrode active material, magnesium or aluminum is used as a negative electrode active material, an aqueous electrolytic solution is used as an electrolyte, and thus the primary battery can be expected to be a battery including inexpensive materials and giving a low environmental load.

The positive electrode 101 can contain a positive electrode active material and a conductive auxiliary agent as constituent elements. Furthermore, the positive electrode 101 preferably contains a binder to integrate the materials.

The negative electrode 103 can contain a negative electrode active material and a conductive auxiliary agent as constituent elements. Furthermore, the negative electrode 103 preferably contains a binder to integrate the materials.

Each of the above constituent elements will be described below.

### (1) Positive Electrode

The positive electrode contains at least a positive electrode active material, and can contain additives such as a conductive auxiliary agent and a binder as necessary. The positive electrode may be formed on a sheet-like current collector containing at least one selected from the group consisting of copper, iron, and carbon.

### (1-1) Positive Electrode Active Material

The positive electrode active material of the present embodiment contains at least isatin.

The positive electrode active material has a particle size of preferably 0.3 μm to 10 μm, more preferably 0.5 μm to 5 μm.

The reason for this is that, as the particle size is smaller, whereas the number of sites to be reacted increases and output performance is improved, elution into the electrolytic solution is promoted and a discharge capacity is reduced.

Isatin can be obtained, for example, as a commercially available product or through known synthesis.

### (1-2) Conductive Auxiliary Agent

In the present embodiment, the positive electrode may contain a conductive auxiliary agent. As the conductive auxiliary agent, for example, carbon can be used. Specific examples of carbon include carbon blacks such as Ketjen black and acetylene black, activated carbons, graphites, and carbon fibers. In order to sufficiently ensure a reaction site in the positive electrode, carbon having a small particle size is suitable. Specifically, carbon having a particle size of 1 μm or less is desirable. Such carbon can be obtained, for example, as a commercially available product or by a known synthesis.

The positive electrode active material may be directly coated with carbon. Examples of the coating method include physical methods such as vapor deposition, sputtering, and a planetary ball mill, chemical methods such as coating with an organic substance followed by heat treatment, and known methods.

### (1-3) Binder

The positive electrode may contain a binder. The binder is not particularly limited, and examples of the binder include polytetrafluoroethylene (PTFE), polyvinylidene fluoride (PVDF), styrene butadiene rubber, ethylene propylene diene rubber, and natural rubber. Styrene butadiene rubber, ethylene propylene diene rubber, and natural rubber, which are formed using no fluorine, are more preferable from viewpoints of an environmental load and disposal treatment.

These binders can be used in a powder or dispersion liquid.

Regarding the contents of the positive electrode active material, the conductive auxiliary agent, and the binder in the positive electrode of the present embodiment, the content of the positive electrode active material is more than 0% by weight and 99% or less and preferably 70 to 95% by weight, the content of the conductive auxiliary agent is 0 to 90% by weight and preferably 1 to 30% by weight, and the content of the binder is 0 to 50% by weight and preferably 1 to 30% by weight based on the weight of the entire positive electrode.

### (1-4) Preparation of Positive Electrode

The positive electrode can be prepared as follows. The positive electrode can be formed by mixing an isatin powder as a positive electrode active material, a carbon powder, and as necessary, a dispersion such as styrene butadiene rubber, applying the mixture to a current collector, and drying the mixture.

The current collector is not particularly limited, and for example, a sheet-like or mesh-like current collector can be used in which at least one (one element) selected from the group consisting of copper, iron, titanium, nickel, and carbon is used.

In order to assemble a battery into a bipolar stack structure described below, the current collector is preferably a sheet-like current collector. The current collector is more preferably a sheet-like current collector containing at least one selected from the group consisting of copper, iron, and carbon from viewpoints of an environmental load and disposal. As described above, the positive electrode is preferably applied to a sheet-like current collector containing at least one selected from the group consisting of copper, iron, and carbon.

In order to increase the strength of the electrode, cold pressing or hot pressing is applied to the dried electrode, and thus a more stable positive electrode can be produced.

As described above, by producing the positive electrode containing isatin as a positive electrode active material, a positive electrode highly active to a discharge reaction can be obtained. Furthermore, by producing the positive electrode of the primary battery having the above-described configuration, it is possible to sufficiently draw the potential of isatin as a positive electrode active material.

### (2) Negative Electrode

The negative electrode contains at least a negative electrode active material, and can contain additives such as a conductive auxiliary agent and a binder as necessary. The negative electrode may be formed on a sheet-like current collector containing at least one selected from the group consisting of copper, iron, and carbon.

### (2-1) Negative Electrode Active Material

The negative electrode active material of the present embodiment contains at least magnesium (Mg) or aluminum (Al).

The negative electrode active material only needs to contain magnesium (Mg) or aluminum (Al) as a main component, and may be an alloy containing at least one component selected from the group consisting of zinc (Zn), calcium (Ca), lithium (Li), manganese (Mn), iron (Fe), tin (Sn), and carbon (C) in addition to magnesium (Mg) or aluminum (Al).

The negative electrode active material can be produced by molding a magnesium (Mg) foil or an aluminum (Al) foil into a predetermined shape.

Magnesium (Mg) or aluminum (Al) may be used in a powder form. However, if magnesium (Mg) or aluminum (Al) is used in a powder form, whereas the number of sites to be reacted increases and output performance is improved, progress of oxidation of magnesium (Mg) or aluminum (Al) and corrosion by the electrolytic solution is accelerated. Therefore, magnesium (Mg) or aluminum (Al) is preferably used in a foil form or a bulk form.

### (2-2) Conductive Auxiliary Agent

In a case of using the negative electrode active material in a powder form, the negative electrode may contain a conductive auxiliary agent. As the conductive auxiliary agent, for example, carbon can be used. Specific examples of carbon include carbon blacks such as Ketjen black and acetylene black, activated carbons, graphites, and carbon fibers. In order to sufficiently ensure a reaction site in the negative electrode, carbon having a small particle size is suitable. Specifically, carbon having a particle size of 1 μm or less is desirable. Such carbon can be obtained, for example, as a commercially available product or by a known synthesis.

The negative electrode active material may be directly coated with carbon. Examples of the coating method include physical methods such as vapor deposition, sputtering, and a planetary ball mill, chemical methods such as coating with an organic substance followed by heat treatment, and known methods.

### (2-3) Binder

In a case of using the negative electrode active material in a powder form, the negative electrode may contain a binder. The binder is not particularly limited, and examples of the binder include polytetrafluoroethylene (PTFE), polyvinylidene fluoride (PVDF), styrene butadiene rubber, ethylene propylene diene rubber, and natural rubber. Styrene butadiene rubber, ethylene propylene diene rubber, and natural rubber, which are formed using no fluorine, are more preferable from viewpoints of an environmental load and disposal treatment. These binders can be used in a powder or dispersion liquid.

Regarding the contents of the negative electrode active material, the conductive auxiliary agent, and the binder in the case of using the negative electrode active material in a powder form, the content of the negative electrode active material is more than 0% by weight and 99% or less and preferably 70 to 95% by weight, the content of the conductive auxiliary agent is 0 to 90% by weight and preferably 1 to 30% by weight, and the content of the binder is 0 to 50% by weight and preferably 1 to 30% by weight based on the weight of the entire negative electrode.

### (2-4) Preparation of Negative Electrode

The negative electrode can be prepared as follows. The negative electrode can be formed by processing magnesium (Mg) foil or aluminum (Al) foil into a predetermined shape and attaching the negative electrode active material to a current collector by welding or the like.

The current collector is not particularly limited, and for example, a sheet-like or mesh-like current collector can be used in which at least one (one element) selected from the group consisting of copper, iron, titanium, nickel, and carbon is used.

In order to assemble a battery into a bipolar stack structure described below, the current collector is preferably a sheet-like current collector. The current collector is more preferably a sheet-like current collector containing at least one selected from the group consisting of copper, iron, and carbon from viewpoints of an environmental load and disposal. As described above, the negative electrode is preferably formed on a sheet-like current collector containing at least one selected from the group consisting of copper, iron, and carbon.

In the case of using the negative electrode active material in a powder form, the negative electrode active material can be prepared as follows. The negative electrode can be formed by mixing a magnesium (Mg) powder or an aluminum (Al) powder as a negative electrode active material, a carbon powder, and as necessary, a dispersion such as styrene butadiene rubber, applying the mixture to a current collector, and drying the mixture.

In order to increase the strength of the electrode, cold pressing or hot pressing is applied to the dried electrode, and thus a more stable negative electrode can be produced.

As described above, by producing the negative electrode containing magnesium (Mg) or aluminum (Al) as a negative electrode active material, a highly active negative electrode can be obtained. Furthermore, by producing the negative electrode of the primary battery having the above-described configuration, it is possible to sufficiently draw a potential of magnesium (Mg) or aluminum (Al) as a negative electrode active material.

### (3) Aqueous Electrolytic Solution (Electrolyte)

The primary battery of the present embodiment contains an aqueous electrolytic solution. This aqueous electrolytic solution is an aqueous solution containing an electrolyte in which hydrogen ions (H⁺) can move. The aqueous electrolytic solution may contain water as a main solvent and contain a solvent other than water. As the aqueous electrolytic solution, for example, an aqueous solution can be used that is obtained by dissolving at least one electrolyte selected from the group consisting of a sulfate, an acetate, a carbonate, a phosphate, a pyrophosphate, a metaphosphate, a citrate, a borate, an ammonium salt, a formate, a hydrogen carbonate, a hydroxide, and a chloride in water.

In the present embodiment, the aqueous electrolytic solution is used as the electrolyte, but a solid electrolyte such as an electrolyte in a gel form or an electrolyte in a solid form may be used. That is, the electrolyte may be in any form such as a liquid form, a cream form, a gel form, or a solid form.

In a case of using an acidic aqueous solution or an alkaline aqueous solution as the aqueous electrolytic solution, the electrolytic solution preferably has a pH of 5.8 or more and 8.6 or less. Usually, the performance of the electrolytic solution is improved as the electrolytic solution is a stronger alkali, but an organic substance such as isatin has weak alkali resistance and is eluted into the electrolytic solution.

In the Water Pollution Control Act as a national law, an allowable limit of pH (hydrogen ion concentration) of a waste liquid discharged into a public water area other than a sea area is set to 5.8 or more and 8.6 or less. Therefore, the pH (hydrogen ion concentration) of the aqueous electrolytic solution is preferably 5.8 or higher and 8.6 or lower from the viewpoints of an environmental load and disposal treatment.

### (4) Other Elements

The primary battery of the present embodiment can include, in addition to the above constituent elements, a structural member such as a separator or a battery case, and other elements required for the primary battery. As these elements, conventionally known ones can be used, but these elements preferably do not contain a harmful substance, a rare metal, a rare earth, and the like from viewpoints of an environmental load and disposal treatment. Furthermore, these other elements are more preferably bio-derived or biodegradable materials.

### (5) Method for Manufacturing Primary Battery

As described above, the primary battery of the present embodiment includes at least a positive electrode, a negative electrode, and an aqueous electrolytic solution, and as illustrated in FIG. 1, the aqueous electrolytic solution is disposed between the positive electrode and the negative electrode so as to be in contact with the positive electrode and the negative electrode. The primary battery having such a configuration can be prepared similarly to a conventional primary battery.

For example, the primary battery may be obtained by assembling the elements including, as described above, a positive electrode including a positive electrode active material containing isatin, a conductive auxiliary agent, and a binder, a negative electrode containing magnesium (Mg) or aluminum (Al), and an aqueous electrolytic solution disposed to be in contact with the positive electrode and the negative electrode, in accordance with a conventional technique.

### (5-1) Method for Manufacturing Coin-Type Primary Battery

As an embodiment of the method for manufacturing a primary battery, for example, a coin-type primary battery can be manufactured.

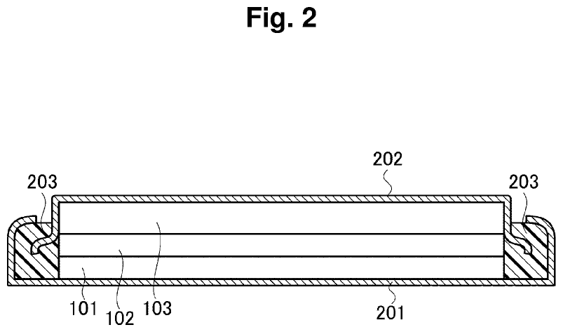

FIG. 2 is a schematic cross-sectional view illustrating a structure of a coin-type primary battery. Specifically, first, a separator (not illustrated) is placed on a positive electrode case 201 in which the positive electrode 101 is disposed, and the electrolytic solution 102 is injected into the placed separator. Next, the negative electrode 103 is disposed on the electrolytic solution 102, and the positive electrode case 201 is covered with a negative electrode case 202. Next, a peripheral portion of the positive electrode case 201 and the negative electrode case 202 is crimped with a coin cell crimping machine, and thus a coin-type primary battery including a propylene gasket 203 can be produced.

The illustrated coin-type primary battery uses an isatin powder as a positive electrode active material. Therefore, unlike an air battery using oxygen in the air as a positive electrode active material, the positive electrode case 201 of the present embodiment needs no air intake port. That is, in the present embodiment, a sealed battery can be produced. Therefore, the primary battery of the present embodiment can be stored for a long period of time without volatilization of the electrolytic solution from an air intake port.

### (5-2) Method for Manufacturing Bipolar Stack Structure

### Primary Battery

As an embodiment of the method for manufacturing a primary battery, for example, a primary battery having a bipolar stack structure can be manufactured.

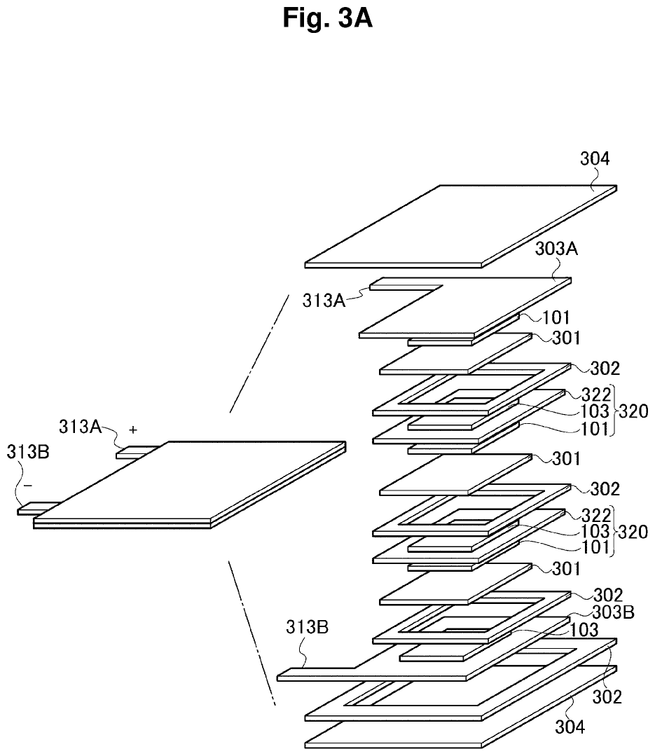

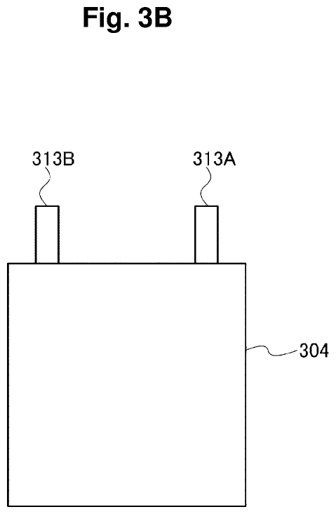

FIG. 3A is a configuration diagram illustrating a configuration example of a bipolar stack primary battery. FIG. 3B is a plan view illustrating a configuration example of a bipolar stack primary battery.

The primary battery of the present embodiment uses the aqueous electrolytic solution, and therefore cannot be expected regarding a battery voltage. Therefore, it is preferable to increase the voltage by forming a primary battery having a stack structure.

Specifically, first, the positive electrode 101 and the negative electrode 103 are joined to both surfaces of a current collector 322 such as a copper foil, respectively to form the positive electrode 101 and the negative electrode 103 on the one current collector 322. As a result, a bipolar electrode 320 is produced in which the positive electrode 101 and the negative electrode 103 are formed on the surfaces of the current collector 322, respectively.

Outermost layer current collectors 303A and 303B are each only need to have only one surface on which an electrode is formed, and preferably have tabs 313A and 313B for extracting electricity, respectively. The illustrated outermost layer current collector 303A has only one surface on which the positive electrode 101 is formed, and has the tab 313A. The outermost layer current collector 303B has only one surface on which the negative electrode 103 is formed, and has the tab 313B.

The tabs 313A and 313B may be processed so as to protrude from the current collectors 303A and 303B, respectively, or another metal tab may be joined to each of the current collectors 303A and 303B by ultrasonic welding, spot welding, or the like.

The current collectors 322 on each of which the positive electrode 101 and the negative electrode 103 are formed are stacked such that the positive electrode 101 and the negative electrode 103 face each other, and a separator 301 is inserted between the current collectors 322 so as to be in contact with the positive electrode 101 and the negative electrode 103. The outermost layer current collectors 303A and 303B on which the positive electrode 101 and the negative electrode 103 are formed, respectively are each also stacked similarly such that the positive electrode 101 and the negative electrode 103 face each other, and the separator 301 is inserted so as to be in contact with the positive electrode 101 and the negative electrode 103.

After the current collectors 303A, 303B, and 322 and the separators 301 are stacked, a peripheral portion of copper foils of the current collectors is thermally pressed using a thermally fusible sheet 302 to be sealed. However, one side (part) of the peripheral portion is to be open, without being thermally pressed, in order to inject an aqueous electrolytic solution described below.

The produced stack is sandwiched between aluminum laminate films 304 or the like, and an aqueous electrolytic solution is injected into each cell (each room), then the unsealed side of the stack and a peripheral portion of the aluminum laminate films are vacuum-sealed, and thus a bipolar stack structure primary battery can be produced.

Such a primary battery is a sealed battery that needs no air intake port, unlike an air battery using oxygen in the air as a positive electrode active material. Therefore, the primary battery of the present embodiment can be stored for a long period of time without volatilization of the electrolytic solution from an air intake port.

### EXAMPLES

Hereinafter, Examples of the primary battery according to the present embodiment will be described in detail. In each of Examples, a primary battery using magnesium (Mg) in the negative electrode and a primary battery using aluminum (Al) in the negative electrode were produced. Note that the present invention is not limited to those described in the following Examples, and can be appropriately modified and implemented without changing the gist thereof.

### Example 1

In Example 1, the above-described coin-type primary battery (FIG. 2) was produced with the following procedure. As a negative electrode active material, a magnesium (Mg) foil and an aluminum (Al) foil were each used. In a primary battery in which magnesium (Mg) was used for a negative electrode, a 2.0 mol/L magnesium sulfate aqueous solution (MgSO₄) was used as an aqueous electrolytic solution. In a primary battery in which aluminum (Al) was used for a negative electrode, a 2.0 mol/L aluminum sulfate aqueous solution (Al₂(SO₄)₃) was used as an aqueous electrolytic solution.

### Preparation of Positive Electrode

An isatin powder (Tokyo Chemical Industry Co., Ltd.), a Ketjen black powder (EC600JD, Lion Specialty Chemicals Co., Ltd.), and a polytetrafluoroethylene (PTFE) powder were sufficiently pulverized and mixed at the weight ratio of 80:10:10 using a pounding machine, and roll-formed to produce a sheet-like electrode (having the thickness of 0.5 mm). This sheet-like electrode was cut into a circle having a diameter of 16 mm and pressed on a copper mesh to obtain a positive electrode.

### Preparation of Negative Electrode

A magnesium (Mg) foil (thickness: 150 μm, The Nilaco Corporation) and an aluminum (Al) foil (thickness: 150 μm, The Nilaco Corporation) were each cut into a circle having a diameter of 16 mm to obtain negative electrodes.

### Preparation of Primary Battery

A coin-type primary battery illustrated in FIG. 2 was produced using a coin battery case (Hohsen Corp.).

A cellulose-based separator (Nippon Kodoshi Corporation) cut into a circle having a diameter of 18 mm was placed on the positive electrode case 201 in which the positive electrode 101 prepared in the above-described method was disposed, and a 2.0 mol/L magnesium sulfate aqueous solution (MgSO₄) and an aluminum sulfate aqueous solution (Al₂(SO₄)₃) were injected as the aqueous electrolytic solution 102 into the placed separator. The negative electrode 103 was disposed on the aqueous electrolytic solution 102, the positive electrode case 201 was covered with the negative electrode case 202, a peripheral portion of the positive electrode case 201 and the negative electrode case 202 was crimped with a coin cell crimping machine, and thus a coin-type primary battery including the propylene gasket 203 was obtained.

### Battery Performance

The battery performance of the primary battery adjusted by the above-described procedure was measured. In a cycle test of the battery, a current was caused to flow at a current density per effective area of the positive electrode of 1 mA/cm² using a charge/discharge measurement system (manufactured by Bio Logic), and a discharge voltage was measured until a battery voltage decreased from an open circuit voltage to 0.20 V. The discharge test of the battery was performed under a normal living environment. The discharge capacity is represented by a value (mAh/g) per unit weight of the positive electrode active material (isatin).

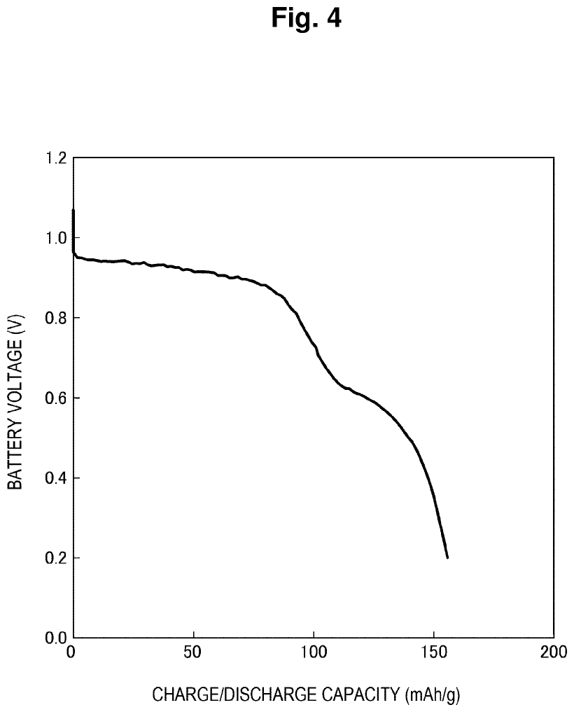

FIG. 4 illustrates a discharge curve in a case of using magnesium (Mg) in the negative electrode. It can be seen from FIG. 4 that the average discharge voltage is 0.9 V and the discharge capacity is 155 mAh/g when isatin is used as a positive electrode active material. Here, an average discharge voltage is defined as a discharge voltage at a discharge capacity (here, 78 mAh/g) of ½ of the total discharge capacity.

Table 1 below shows the discharge voltage and the discharge capacity of the primary batteries in which magnesium (Mg) and aluminum (Al) are used in the negative electrode respectively. As described above, it has been found that each primary battery in Example 1 has excellent battery performance.

TABLE 1

| Examples | Negative electrode active material | Mg | Al |
|---|---|---|---|
| Example 1 | Discharge voltage (V) | 0.9 | 0.5 |
| | Discharge capacity (mAh/g) | 155 | 140 |
| Example 2 | Discharge voltage (V) | 1.2 | 1.0 |
| | Discharge capacity (mAh/g) | 200 | 185 |
| Example 4 | Discharge voltage (V) | 3.6 | 3.0 |
| | Discharge capacity (mAh/g) | 210 | 190 |

### Example 2

In Example 2, the above-described coin-type primary battery was produced with the following procedure. The positive electrode was applied to a copper sheet-like current collector and thus prepared, and the negative electrode was welded to a copper sheet-like current collector and thus prepared. As in Example 1, for an aqueous electrolytic solution, a 2.0 mol/L magnesium sulfate aqueous solution (MgSO₄) was used when magnesium (Mg) was used for the negative electrode, and a 2.0 mol/L aluminum sulfate aqueous solution (Al₂(SO₄)₃) was used when aluminum (Al) was for the negative electrode. The battery was produced and evaluated in a manner similar to that in Example 1.

### Preparation of Positive Electrode

An isatin powder (Tokyo Chemical Industry Co., Ltd.), a Ketjen black powder (EC600JD, Lion Specialty Chemicals Co., Ltd.), and styrene butadiene rubber (AA Portable Power Corporation) were sufficiently mixed at a weight ratio of 80:10:10 using a kneader (Thinky Corporation) to produce a slurry. This slurry was applied to a copper foil (The Nilaco Corporation) and dried in a vacuum dryer at 100° C. for 12 hours. Thereafter, the dried product was pressed at 120° C., and this sheet-like electrode was cut into a circle having a diameter of 16 mm to obtain a positive electrode.

### Preparation of Negative Electrode

A magnesium (Mg) foil (thickness: 150 μm, The Nilaco Corporation) and an aluminum (Al) foil (thickness: 150 μm, The Nilaco Corporation) were each cut into a circle having a diameter of 16 mm, and each of the resulting circular foils was joined to a copper foil (The Nilaco Corporation) using an ultrasonic welding machine.

### Battery Performance

Table 1 shows the discharge capacity and the discharge voltage of the primary batteries in Example 2. As shown in Table 1, the discharge capacity of the battery using magnesium (Mg) for the negative electrode in Example 2 was 200 mAh/g, which is greater than that in Example 1. The discharge capacity of the battery using aluminum (Al) in the negative electrode in Example 2 was also larger than that in Example 1.

As shown in Table 1, the discharge voltage in Example 2 is larger than the discharge voltage in Example 1. That is, a larger decrease in overvoltage was observed in Example 2 than in Example 1, and improvement in discharge energy efficiency was achieved.

It is considered that these characteristics were improved because each of the positive electrode and the negative electrode was formed by being joined to a copper sheet-like current collector, internal resistance of the battery was thereby reduced, and a battery reaction was smoothly performed.

### Example 3

In Example 3, the above-described primary battery having a bipolar three-stack structure was produced according to the following procedure.

FIG. 3A is an exploded view of the primary battery having a bipolar three-stack structure. As in Examples 1 and 2, for an aqueous electrolytic solution, a 2.0 mol/L magnesium sulfate aqueous solution (MgSO₄) was used when magnesium (Mg) was used for the negative electrode, and a 2.0 mol/L aluminum sulfate aqueous solution (Al₂(SO₄)₃) was used when aluminum (Al) was for the negative electrode.

The battery was evaluated in a manner similar to that in Examples 1 and 2. Note that the measurement in the charge/discharge test was performed until the discharge voltage decreased to 0.6 V.

### Preparation of Positive Electrode and Negative Electrode

Magnesium (Mg) foil (thickness: 150 μm, The Nilaco Corporation) and aluminum (Al) foil (thickness: 150 μm, The Nilaco Corporation) were each cut into 2 cm×2 cm as the negative electrodes 103, and each of the negative electrodes 103 was joined to a copper foil (The Nilaco Corporation) using an ultrasonic welding machine.

Next, as the positive electrode 101, an isatin powder (Tokyo Chemical Industry Co., Ltd.), a Ketjen black powder (EC600JD, Lion Specialty Chemicals Co., Ltd.), and styrene butadiene rubber (AA Portable Power Corporation) were sufficiently mixed at a weight ratio of 80:10:10 using a kneader (Thinky Corporation) to produce a slurry.

This slurry was applied to the back surface of the above-described copper foil (the current collector 322) to which the negative electrode was bonded as earlier in a size of 2 cm×2 cm, and dried in a vacuum dryer at 100° C. for 12 hours. Thereafter, the dried product was pressed at 120°° C. to obtain the bipolar electrode 320 having surfaces on which the positive electrode 101 and the negative electrode 103 were joined, respectively.

Note that, as for the outermost layer electrode for the positive electrode 101 and the outermost layer electrode for the negative electrode 103, the above-described positive electrode 101 or negative electrode 103 was joined to only one surface of the above-described copper foil (each of the current collectors 303A and 303B). An adjustment method is similar to that described above. As the copper foils (the current collectors 303A and 303B) for the outermost layers, copper foils cut into shapes having the tabs 313A and 313B were used, respectively.

### Preparation of Primary Battery

A primary battery having a bipolar three-stack structure illustrated in FIG. 3 was produced using aluminum laminate films 304.

The two bipolar electrodes 320 prepared with the above-described method were stacked so that the positive electrode 101 and the negative electrode 103 faced each other, and a separator 301 cut out into 2.2 cm×2.2 cm and a frame-shaped thermally fusible sheet 302 having a cut-out center portion were inserted between the bipolar electrodes 320. After stacking, three sides of a peripheral portion of the current collectors 322 were thermally pressed at 180° C. to be sealed.

As for the outermost layers, in a manner similar to that described above, the negative electrode 103, the positive electrode 101, the separators 301, and the thermally fusible sheet 302 for the outermost layers were also stacked such that the positive electrode 101 and the negative electrode 103 faced each other, and the same three sides as the sides sealed above were thermally pressed to be sealed.

The stack thus produced was sandwiched between the aluminum laminate film 304 and the thermally fusible sheet 302, and the same three sides as the sides sealed above were thermally pressed to form the aluminum laminate films into a bag shape.

Thereafter, the 2.0 mol/L magnesium sulfate aqueous solution (MgSO₄) and aluminum sulfate aqueous solution (Al₂(SO₄)₃) were injected into each cell (room) of the stack structure, the separator 301 was sufficiently immersed therein, then one unsealed side of the aluminum laminate film 304 was and finally one unsealed side of the stack was sealed from above of the aluminum laminate film 304, thereby a bipolar stack primary battery was obtained.

Note that, in Example 3, the bipolar three-stack primary battery was produced, but a bipolar three or more-stack primary battery can be produced, and in this case, it is only required to increase the number of bipolar electrodes 320 to be stacked.

### Battery Performance

Table 1 shows the discharge capacity and the discharge voltage of the primary batteries in this Example. As shown in Table 1, the discharge capacity of the battery in which magnesium (Mg) was used in the negative electrode in Example 3 was 210 mAh/g, and this value was equivalent to that in Example 2. The discharge capacity of the battery using aluminum (Al) in the negative electrode in Example 3 was also equivalent to that in Example 2.

Furthermore, as shown in Table 1, the discharge voltage is also about three times that in Example 2, and thus a voltage equivalent to that of a conventional lithium ion battery can be achieved by forming a bipolar stack structure primary battery.

From the above results, the primary battery of the present embodiment gives a low environmental load and can simplify disposal treatment by using isatin as a positive electrode active material and using magnesium or aluminum as a negative electrode active material.

In addition, the primary battery of the present embodiment is a sealed battery that needs no air intake port unlike an air battery. Therefore, the primary battery of the present embodiment can be stored for a long period of time without volatilization of the electrolytic solution from an air intake port.

As the electrolyte, an aqueous electrolytic solution is preferably used. In a case of using an organic electrolytic solution, a fire, an explosion, and the like may be caused because the organic electrolytic solution easily burns, and there is a concern about an adverse effect on a human body and an environment at the time of leakage of the organic electrolytic solution. On the other hand, in the present embodiment, an inexpensive battery having high safety can be produced by using an aqueous electrolytic solution.

The aqueous electrolytic solution preferably has a pH of 5.8 or more and 8.6 or less. As a result, a battery that is environmentally friendly and can be easily discarded can be produced.

Therefore, the primary battery of the present embodiment can be effectively used as a new drive source for various electronic devices such as small devices, sensors, and mobile devices.

Note that the present invention is not limited to the above embodiment, and various modifications and combinations are possible within the technical idea of the present invention.

### REFERENCE SIGNS LIST

101 Positive electrode
102 Aqueous electrolytic solution (electrolyte)
103 Negative electrode
201 Positive electrode case
202 Negative electrode case
203 Propylene gasket
301 Separator
302 Thermally fusible sheet
303A, 303B Outermost layer current collector
304 Aluminum laminate film
320 Bipolar electrode
322 Current collector

1. A primary battery comprising:
a positive electrode containing isatin;
a negative electrode containing magnesium or aluminum; and
an electrolyte disposed between the positive electrode and the negative electrode.

2. The primary battery according to claim 1, wherein the positive electrode and the negative electrode are each formed on a sheet-like current collector containing at least one selected from the group consisting of copper, iron, and carbon.

3. The primary battery according to claim 1, having a bipolar stack structure.

4. The primary battery according to claim 2, having a bipolar stack structure.
